(19) United States
(12) Patent Application Publication
(10) Pub. No.: US 2019/0155341 A1
(43) Pub. Date: May 23, 2019

(54) SYSTEMS AND METHODS FOR SUPPORTING USER DISCONNECTION FROM ELECTRONIC DEVICES

(71) Applicant: Brick, LLC, Los Angeles, CA (US)

(72) Inventor: Thomas L. Sobel, Los Angeles, CA (US)

(73) Assignee: Brick, LLC, Los Angeles, CA (US)

(21) Appl. No.: 16/199,081

(22) Filed: Nov. 23, 2018

Related U.S. Application Data
(60) Provisional application No. 62/590,247, filed on Nov. 22, 2017.
(60) Provisional application No. 62/628,898, filed on Feb. 9, 2018.

(51) Int. Cl. G06F 1/16; G06F 11/30; H04W 4/80; G01G 3/12

(52) U.S. Cl. CPC G06F 1/1658; G06F 11/3055; G01G 3/12; H04W 4/80; G06F 11/3062

(57) ABSTRACT

A container for supporting user disconnection from one or more mobile devices, the container comprising a housing comprising an internal cavity and a door providing access to the internal cavity, the internal cavity being configured to store one or more mobile devices. The container includes sensors and a computing system. A mobile device is determined to be in the housing. The mobile device is associated with a user-connected state prior to the determining. A mobile device system executing on the mobile device starts logging user-disconnection time and provide a user-disconnected state message indicating a user-disconnected state associated with the mobile device to a server system. A mobile device system logs user-disconnected statistics based on these determinations and displays them to the user and to one or more other mobile device systems or networks.

### CROSS-REFERENCE TO RELATED APPLICATIONS

The present application claims the benefit of U.S. Provisional Patent Application Ser. 62/590,247, filed Nov. 22, 2017, and entitled “Systems and Methods for Supporting User Disconnection from an Electronic Device,” and U.S. Provisional Patent Application Ser. 62/628,898, filed Feb. 9, 2018, and entitled “Brick Puzzle Game Box,” which are both hereby incorporated by reference herein.

### TECHNICAL FIELD

This disclosure pertains to systems for supporting user disconnection from electronic devices (e.g., mobile devices).

### BACKGROUND

Users often spend several hours or more per day interacting with their electronic devices. For example, users may spend hours using their mobile devices to browse the web, reply to emails, play games, shop, and/or the like. It is often difficult for users to disconnect and remain disconnected from their devices. For example, a user may turn off their device and/or various features of their device (e.g., network connectivity) in an attempt to disconnect. However, the devices and/or services are intentionally easy to turn back on, which makes it difficult for users to stay disconnected.

### SUMMARY

In various embodiments, a system is configured to support user disconnection from electronic devices (e.g., mobile devices). The system may be configured to provide a user-disconnection mode of operation for a mobile device, and measure user-disconnection time (e.g., time spent in user-disconnection mode). As used herein, “user-disconnection time” may refer to a user-disconnection mode and/or an amount of time spent in user-disconnection mode. User-disconnection mode may or more not limit functionality of an associated mobile device. For example, user-disconnection mode may require the mobile device be in airplane mode and/or otherwise limit functionality of the mobile device (e.g., turn the mobile device off and/or temporarily disconnect the mobile device). In other embodiments, such as when the mobile device is in a user-disconnection box, functionality of the mobile device may not be limited and/or may be limited differently. For example, the display of the mobile device may be turned off, but network connections may remain active.

Various embodiments of the present disclosure include a container for supporting user disconnection from one or more mobile devices. The container may comprise a housing comprising an internal cavity and a door providing access to the internal cavity. The internal cavity may be configured to store one or more mobile devices. One or more sensors may be disposed within the internal cavity of the housing. The container may include one or more processors, and memory storing instructions that, when executed by the one or more processors, cause a computing system to determine a mobile device is in the internal cavity of the housing based on the one or more sensors, the mobile device being associated with a user-connected state prior to the determination the mobile device in the housing. The computing system may trigger, in response to the determining the mobile device is in the internal cavity of the housing, a user-disconnected state associated with the mobile device, thereby causing a mobile device system executing on the mobile device to start logging user-disconnection time and provide a user-disconnected state message indicating a user-disconnected state associated with the mobile device to a server system, the server system being capable of notifying at least one other user of the user-disconnected state associated with the mobile device.

In some embodiments, the one or more sensors comprise one or more weight sensors configured to detect one or more weight values of a mobile device placed in contact with at least one of the one or more weight sensors.

In some embodiments, the one or more sensors comprise one or more radio-frequency identification (RFID) sensors configured to identify a corresponding RFID tag attached to the mobile when the mobile is inside the internal cavity of the housing.

In some embodiments, the user-disconnected state message indicates the start logging user-disconnection time.

In some embodiments, the instructions further cause the computing system to determine the mobile device from is not in the internal cavity of the housing based on the one or more sensors; trigger, in response to the determining the mobile device is not in the internal cavity of the housing, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

In some embodiments, the user-connected state message indicates the end logging user-disconnection time.

In some embodiments, the container further includes a timer dial disposed on the external portion of the housing, the timer dial configured to receive one or more inputs for setting a period of user-disconnection time.

In some embodiments, the instructions further cause the computing system to detect an end of the period of user-disconnection time; trigger, in response to the detecting an of the period of user-disconnection time, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

In some embodiments, the mobile device system is configured to provide an auto-reply message in response to one or more messages received while the mobile device is within the internal cavity of the housing and the mobile device is associated with a user-disconnected state.

In some embodiments, the container further comprises a charging cable configured to facilitate charging of the mobile device.

Various embodiments of the present disclosure include systems, methods, and non-transitory computer readable media configured to determine, based on one or more sensors disposed within an internal cavity of a housing of a container, a mobile device is in the internal cavity of the housing, the mobile device being associated with a user-connected state prior to the determination the mobile device in the housing. In response to the determining the mobile device is in the internal cavity of the housing, a user-disconnected state associated with the mobile device may be triggered, thereby causing a mobile device system executing on the mobile device to start logging user-disconnection time and provide a user-disconnected state message indicating a user-disconnected state associated with the mobile device may be provided to a server system. The server system may be capable of notifying at least one other user of the user-disconnected state associated with the mobile device.

In some embodiments, the one or more sensors comprise one or more weights sensors configured to detect one or more weight values of a mobile device placed in contact with at least one of the one or more weight sensors.

In some embodiments, the one or more sensors comprise one or more radio-frequency identification (RFID) sensors configured to identify a corresponding RFID tag attached to the mobile when the mobile is inside the internal cavity of the housing.

In some embodiments, the user-disconnected state message indicates the start logging user-disconnection time.

In some embodiments, the systems, methods, and non-transitory computer readable media further configured to perform determining the mobile device is not in the internal cavity of the housing based on the one or more sensors; triggering, in response to the determining the mobile device is not in the internal cavity of the housing, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

In some embodiments, the user-connected state message indicates the end logging user-disconnection time.

In some embodiments, the container further includes a timer dial disposed on the external portion of the housing, the timer dial configured to receive one or more inputs for setting a period of user-disconnection time.

In some embodiments, the systems, methods, and non-transitory computer readable media further configured to perform detecting an end of the period of user-disconnection time; triggering, in response to the detecting an end of the period of user-disconnection time, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

In some embodiments, the mobile device system is configured to provide an auto-reply message in response to one or more messages received while the mobile device is within the internal cavity of the housing and the mobile device is associated with a user-disconnected state.

In some embodiments, the container further comprises a charging cable configured to facilitate charging of the mobile device.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a system for supporting user disconnection from electronic devices according to some embodiments.

FIGS. 2A-C depict configurations of a user-disconnection box according to some embodiments.

FIG. 3 depicts a mobile device system according to some embodiments.

FIG. 4 depicts a user-disconnection box system according to some embodiments.

FIG. 5 depicts a server system according to some embodiments.

FIG. 6 depicts a flowchart of a method of operation of a user-disconnection box with network connectivity to a server system according to some embodiments.

FIG. 7 depicts a flowchart of a method of operation of a user-disconnection box detecting removal of a mobile device according to some embodiments.

FIG. 8 depicts a flowchart of a method of operation of a user-disconnection box detecting an end of a period of user-disconnection time according to some embodiments.

FIG. 9 depicts a flowchart of a method of operation of a user-disconnection box without network connectivity to a server system according to some embodiments.

FIG. 10 depicts a flowchart of a method of operation of a mobile device system and a user-disconnection box according to some embodiments.

FIG. 11 depicts a flowchart of a method of operation of a mobile device system without an associated user-disconnection box according to some embodiments.

FIG. 12 depicts a flowchart of a method of operation of a server system according to some embodiments.

FIGS. 13A-B depict a configuration of a user-disconnection box according to some embodiments.

FIGS. 14A-C depict graphical user interfaces of a mobile device system according to some embodiments.

FIGS. 15A-C depict graphical user interfaces of a mobile device system according to some embodiments.

FIG. 16 depicts a computer system for implementing the features disclosed herein according to some embodiments.

### DETAILED DESCRIPTION

In various embodiments, a system is configured to support user disconnection from electronic devices (e.g., mobile devices). The system may be configured to provide a user-disconnection mode of operation for a mobile device, and measure user-disconnection time (e.g., time spent in user-disconnection mode). As used herein, “user-disconnection time” may refer to a user-disconnection mode and/or an amount of time spent in user-disconnection mode. User-disconnection mode may or may not limit functionality of an associated electronic device. For example, user-disconnection mode may require the electronic device be in airplane mode and/or otherwise limit functionality of the electronic device (e.g., turn the electronic device off and/or temporarily disconnect the electronic device from cellular data/internet). In other embodiments, such as when the electronic device is in a user-disconnection box, functionality of the mobile device may not be limited and/or may be limited differently. For example, the display of the electronic device may be turned off and/or ringer silenced, but network connections may remain active.

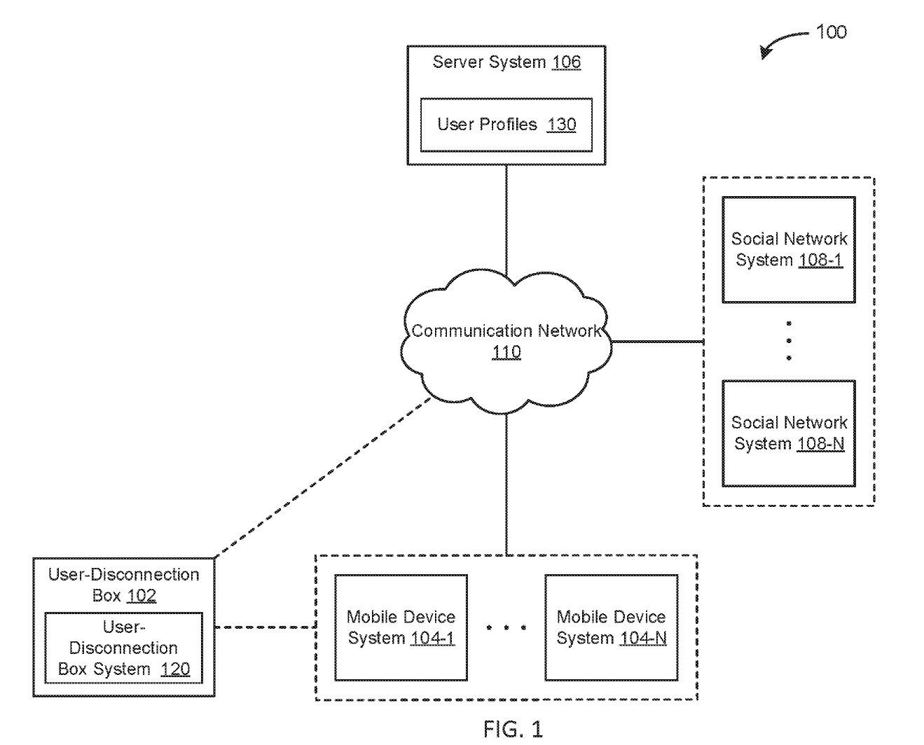

FIG. 1 depicts a system 100 for supporting user disconnection from electronic devices according to some embodiments. In the example of FIG. 1, the system 100 includes a user-disconnection box 102, mobile device systems 104-1 to 104-N (individually, the mobile device system 104, collectively, the mobile device systems 104), a server system 106, social network systems 108-1 to 108-N (individually, the social network system 108, collectively, the social network systems 108), and a communication network 110.

The user-disconnection box 102 may function to prevent and/or otherwise inhibit access to mobile devices (e.g., smartphones, tablet computers, laptop computer, gaming devices) and/or other electronic devices. For example, the user-disconnection box 102 may comprise a container (e.g., a box-shaped container and/or other shaped container) configured to store one or more mobile devices. The user-disconnection box 102 may include a door (or, lid) that may be opened and/or closed. The user-disconnection box 102 may include a locking mechanism (e.g., a magnetic locking mechanism) to lock the door (e.g., in a closed position). The user-disconnection box 102 may include a switch inside the door (or, lid) that is pressed when the door is closed.

In some embodiments, the user-disconnection box 102 may function to indicate user connection states. For example, user connection states may include a user-connected state and a user-disconnected state. A user-connected state may indicate that an associated mobile device is not in user-disconnection time. A user-disconnected state may indicate an associated mobile device is in user-disconnection time. The user-disconnection box 102 may indicate user connection state using one or more indicator lights, indicator sounds, indicator haptics, and/or the like.

In some embodiments, the user-disconnection box 102 includes a user-disconnection box system 120. The user-disconnection box system 120 may comprise a computing system embedded within the user-disconnection box 102 and/or otherwise associated with the user-disconnection box 102. In some embodiments, the user-disconnection box system 120 functions to control and/or utilize various features of the user-disconnection box 102. For example, the user-disconnection box system 120 may detect placement and/or removal of a mobile device within the user-disconnection box 102. In another example, the user-disconnection box system 120 may determine a mobile device is inside the user-disconnection box 102 or not inside the user-disconnection box 120. The user-disconnection box system 120 may also notify other systems (e.g., mobile devices, mobile device systems, and/or a server system) that a mobile device (e.g., a unique mobile device) has been placed and/or removed from the user-disconnection box 102.

In some embodiments, the user-disconnection box system 120 functions to trigger and/or end user-disconnection time. For example, the user-disconnection box system 120 may trigger user-disconnection time in response to detecting placement of a mobile device within the user-disconnection box 102. The user-disconnection box system 120 may end user-disconnection time in response to detecting removal of a mobile device from the user-disconnection box 102. In another example, the user-disconnection box system 120 may trigger user-disconnection time in response to detecting the user-disconnection box 102 door (or, lid) being closed. The user-disconnection box system 120 may end user-disconnection time in response to detecting the door (or, lid) of the box being opened. The user-disconnection box system 120 may also notify a server system 106 of user-disconnection time and/or user connection state. For example, the user-disconnection box system 120 may notify the server system 106 when a mobile device enters user-disconnection time, leaves user-disconnection times, and/or the like.

The mobile device systems 104 may function to provide a user-disconnection mode of operation for a mobile device (e.g., the mobile device implementing mobile device system 104). Functionality of the mobile device systems 104 may be performed by one or more mobile devices. In some embodiments, a mobile device system may comprise a mobile application (or, “app”).

In some embodiments, the mobile device systems 104 function to measure and/or log an amount of time spent in user-disconnection mode. For example, the mobile device systems 104 may log different periods of user-disconnection time, calculate and/or log historical user-disconnection time statistics (e.g., daily totals, daily averages, weekly totals, weekly averages, daily streaks, total historical user-disconnection time). The mobile device systems 104 may provide this information to a remote system (e.g., a server system) for sharing with one or more other remote systems (e.g., social network systems, other mobile devices).

The server system 106 may function to create, read, update, and/or delete user profiles 130. User profiles 130 may be associated with a particular user and/or mobile device/devices and may include user-disconnection time information and/or related information. For example, the user profiles 130 may include historical user-disconnection time statistics, and/or the like. The server system 106 may share some or all user profile 130 information with one or more other users and/or systems. For example, the server system 106 may share information indicating that a particular user is in user-disconnection time. In some embodiments, functionality of the server system 106 may be performed by one or more servers (e.g., cloud-based servers) and/or other computing devices.

The social network systems 108 may each function to receive and/or provide information. For example, the social network system 108 may receive and/or provide information shared from other systems. Social network systems may include Facebook, Instagram, LinkedIn, and/or the like. In various embodiments, functionality of the social network systems 108 may be performed by one or more servers (e.g., a cloud-based server) and/or other computing devices (e.g., mobile devices).

The communications network 110 may represent one or more computer networks (e.g., LAN, WAN, or the like) or other transmission mediums. The communication network 110 may provide communication between some or all of the user-disconnection box 102, the mobile device systems 104, the server system 106, the social network systems 108, and/or other systems, engines, and/or datastores described herein. In some embodiments, the communication network 110 includes one or more computing devices, routers, cables, buses, and/or other network topologies (e.g., mesh, and the like). In some embodiments, the communication network 110 may be wired and/or wireless. In various embodiments, the communication network 110 may include the Internet, one or more wide area networks (WANs) or local area networks (LANs), one or more networks that may be public, private, IP-based, non-IP based, and so forth.

It will be appreciated that functionality of the systems described herein may be included in one or more of the other systems described herein, and/or otherwise have a different arrangement. For example, in some embodiments, some or all of the functionality of the user-disconnection box system 120 may be performed by the mobile device systems 104, and/or vice versa.

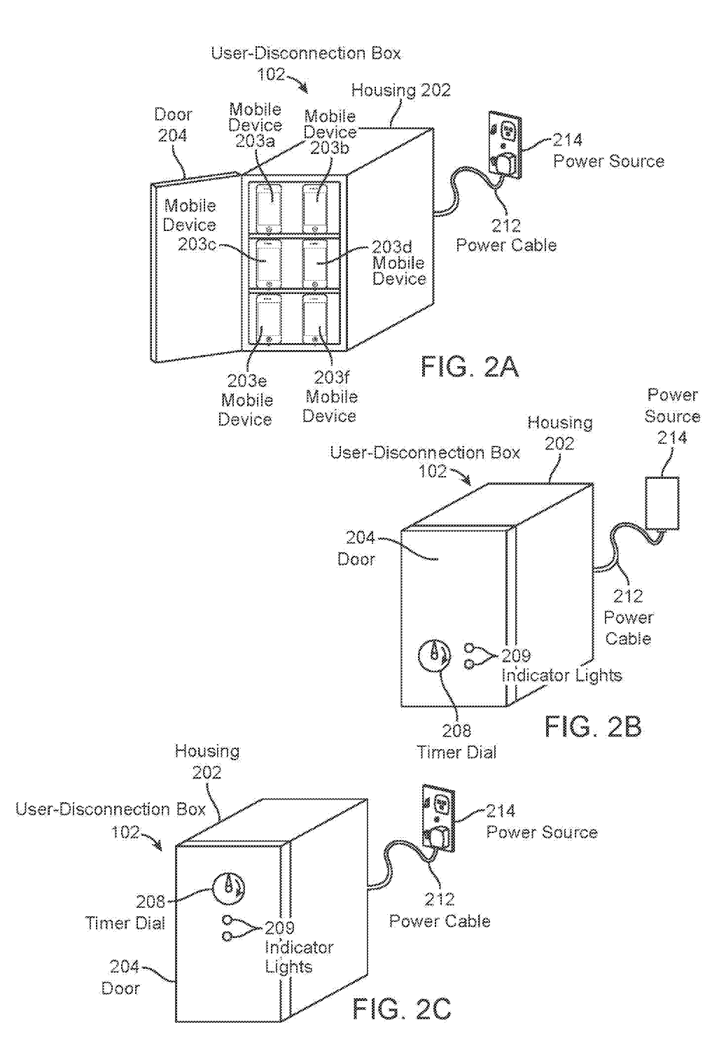

FIGS. 2A-C depict configurations of a user-disconnection box 102 according to some embodiments. Although the user-disconnection box 102 may comprise a box-shaped container, it will be appreciated that the user-disconnection box 102 may comprise a container in a variety of different shapes. In the example of FIG. 2A, the user-disconnection box 102 includes a housing 202, a door (or, lid) 204, and a power cable 212.

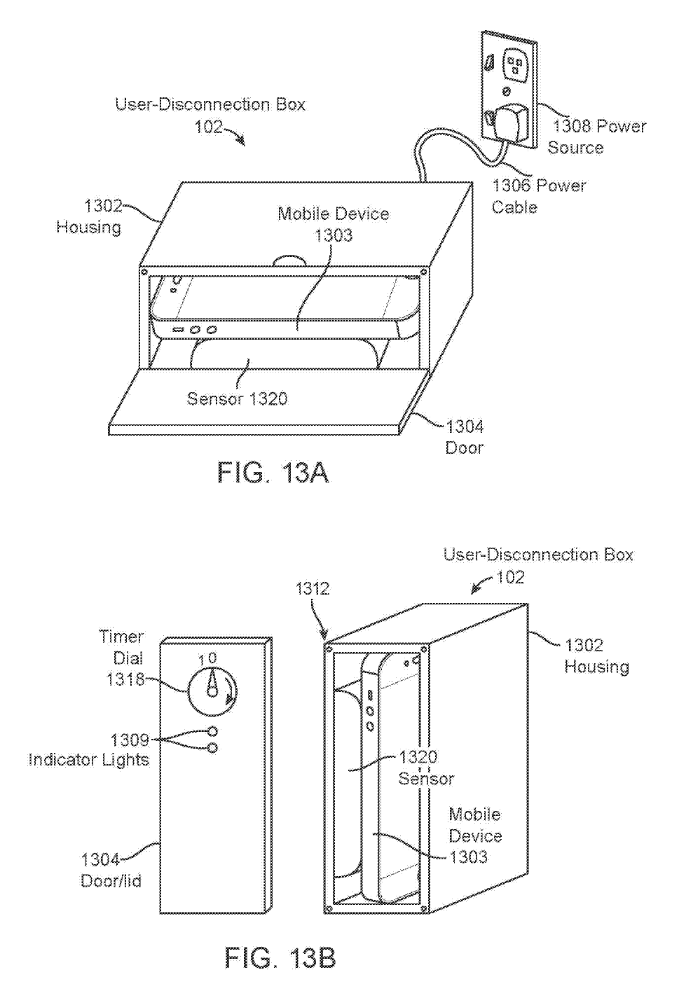

The housing 202 may function to define an internal cavity configured to store one or more mobile devices 203. Although the mobile devices 203 are shown being stored in an upright position, it will be appreciated that this is for illustrative purposes, and the internal cavity may be configured to store mobile devices 203 in a variety of positions (e.g., upright, facing up, facing down, facing sideways, in serial arrangement, or in parallel arrangement). The housing 202 may be rigid and/or flexible. For example, the housing 202 may comprise metals (e.g., aluminum), plastics, woods, ceramics, and/or the like. The housing 202 may be configured to include one or more sensors, as described elsewhere herein. Although the housing 202 is shown here as being configured to store multiple mobile devices 203, some embodiments may specifically size and/or limit the housing to a single mobile device (e.g., as shown in FIGS. 13A-B). Although a single type of mobile device is shown here (such as a smartphone), the housing 202 may be configured to store different types of devices (e.g., smartphones, tablet computers, video game consoles, laptop computers, and/or other electronic devices). Although not shown here, multiple user-disconnection boxes may be placed together modularly to house additional devices (e.g., end to end, side by side, or in parallel).

The door 204 may comprise a portion of the housing 202 (e.g., a front portion, a back portion, a side portion, a top portion, and/or a bottom portion), and/or be moveably attached to the housing 202. For example, the door 204 may comprise a front portion of the housing 202, and may be moved between an open position and a closed position. In some embodiments, the door 204 may be locked and/or unlocked. The door 204 may comprise the same and/or different materials as the housing 202.

The power cable 212 may function to connect the user-disconnection box 102, user-disconnection box system 120, and/or mobile devices 203 to a power source, such as a wall outlet and/or other power source (e.g., battery). The power cable 212 may supplement another power source of the user-disconnection box 102, such as a battery power source.

In some embodiments, the power cable 212 may passed through a port of the housing 202. The port may be configured to receive only the power cable 212 and/or may be configured to receive one or more other cables (e.g., USB cables). In some embodiments, the power cable 212 may connect to a power hub of the user-disconnection box 102 that may provide power to multiple mobile device 203 in the user-disconnection box 102 (e.g., via one or more cable in the ser-disconnection box 102 connecting from the power hub to the mobile devices 203.

In the example of FIG. 2B, the user-disconnection box 102 includes a housing 202, a door 204, a timer dial 208, indicator lights 209, and a power cable 212. The housing 202, the door 204, and the power capable 212 may be the same as those described above.

The timer dial 208 may function to set and/or schedule a period of user-disconnection time (e.g., 2 hours). The timer dial 208 may be configured to receive and/or provide one or more inputs. For example, a user may manipulate the timer dial 208 in a clockwise direction to increase a period of scheduled user-disconnection time, and manipulate the timer dial in a counter-clockwise direction to decrease a period of scheduled user-disconnection time. The timer dial 208 may be analog and/or digital, and may be disposed on an external portion of the housing 202 and/or door 204.

The indicator lights 209 may function to indicate user connection state. For example, the indicator lights 209 may display a green light when a mobile device inside the box is associated with a user-disconnection state (e.g., when it is in user-disconnection time), and the indicator lights 209 may display a red light when a mobile device is associated with a user-connected state (e.g., when it is not in user-disconnection time).

In the example of FIG. 2C, the user-disconnection box 102 includes a housing 202, a door 204, a timer dial 208, indicator lights 209, and a power cable 212. The elements of FIG. 2C may be same as those described above, albeit arranged in a different configuration.

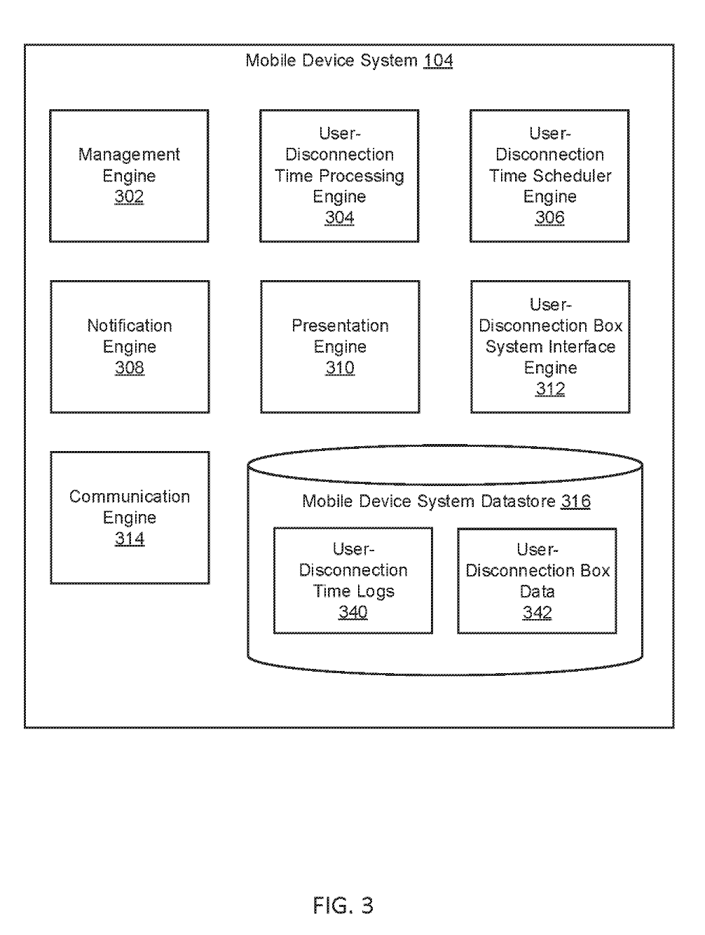

FIG. 3 depicts a mobile device system 104 according to some embodiments. In the example of the FIG. 3, the mobile device system 104 includes a management engine 302, a user-disconnection time processing engine 304, a user-disconnection time scheduler engine 306, a notification engine 308, a presentation engine 310, a user-disconnection box system interface engine 312, a communication engine 314, and a mobile device system datastore 316.

The management engine 302 may function to manage (e.g., create, read, update, delete, or otherwise access) user-disconnection time logs 340 and/or user-disconnection box data 342 stored in the mobile device system datastore 316 and/or other datastore(s) associated with the mobile device system 104. The management engine 302 may perform any of these operations manually (e.g., by a user interacting with a GUI) and/or automatically (e.g., triggered by one or more of the engines 304-314). Like other engines described herein, some or all of the functionality of the management engine 302 may be included in and/or cooperate with one or more other engines (e.g., engines 304-314).

The user-disconnection time processing engine 304 may function to log, measure, and/or calculate user-disconnection time. For example, the user-disconnection time processing engine 304 may log start times and/or end times for user-disconnection time as timestamps in user-disconnection time log 340. The user-disconnection time processing engine 304 may calculate and/or measure an amount of user-disconnection time (e.g., 4 hours, 32 minutes, and 7 seconds) based on the start and/or end times. For example, the user-disconnection time processing engine 304 may convert the start time to a first value (e.g., a numerical value, absolute value), convert the end time to a second value, subtract the first value from the second value to obtain a third value, and convert the third value into a time format (e.g., 2 hours or 2:00:00).

In some embodiments, the user-disconnection time processing engine 304 may start a timer (e.g., a digital clock timer) that tracks user-disconnection time and/or stores the information in a user-disconnection time log 340. The user-disconnection time processing engine 304 may also stop the timer at the end of a period of user-disconnection time. The timer values may be stored in the user-disconnection time log. In some embodiments, the user-disconnection time processing engine 304 may also trigger different user states (e.g., user-disconnected state and/or user-connected state) associated with a mobile device. Triggering a user state may cause the user-disconnection time processing engine 304 to start and/or end a timer. For example, triggering a user-disconnected state may start the timer, and/or triggering a user-connected state may end the timer.

In some embodiments, the user-disconnection time processing engine 304 triggers a mobile device to enter user-disconnection mode. For example, a user operating a mobile device may launch the mobile device system on a mobile device. The user may then restrict one or more features of the mobile device (e.g., place the mobile device in airplane mode), and return to a graphical user interface of the mobile device system (e.g., presented by the presentation engine 310). This may place the mobile device system in user-disconnection mode. Navigating away from the graphical user interface and/or otherwise interacting the mobile device and/or mobile device system may exit user-disconnection mode.

In some embodiments, the user-disconnection time processing engine 304 may function to detect starting and/or ending conditions for user-disconnection time. Starting condition may include restricting particular functionality of a mobile device (e.g., turning on airplane mode), navigating and/or remaining on a particular graphical user interface (e.g., a user-disconnection time homepage of the mobile device system), and/or placing the mobile device in a user-disconnection box. Ending condition may include activating particular functionality of a mobile (e.g., turning off airplane mode), navigating away from a particular graphical user interface, removing the mobile device from a user-disconnection box, and/or reaching the end of a scheduled period of user-disconnection time.

The user-disconnection time scheduler engine 306 may function to schedule user-disconnection time. For example, the user-disconnection time scheduler engine may schedule user-disconnection time for January 18 at 2:00 PM, and/or add a calendar event on a calendar of the mobile device system and/or mobile device (e.g., an Outlook calendar event), which may be shared with one or more users, uploaded to a server system, stored in an associated user profile, and/or the like. In some embodiments, the user-disconnection time scheduler engine 306 functions to receive an alert indicating the scheduled user-disconnection time.

In some embodiments, the user-disconnection time scheduler engine 306 functions to control locking of a user-disconnection box. For example, the user-disconnection time scheduler engine 306 may lock a user-disconnection box at the start of a scheduled period of user-disconnection time and/or unlock a user-disconnection box at an end of scheduled user-disconnection time.

The notification engine 308 may function to generate and/or provide notifications to remote systems (e.g., a server system, social network systems, and/or other mobile devices). Notifications may include auto-reply messages. For example, the notification engine 308 may provide an auto-reply message in response to one or more messages received while the mobile device is placed within a user-disconnection box and the mobile device is associated with a user-disconnected state. For example, if another user using another mobile device sends a text message to the mobile device, the mobile device system may send and/or trigger the mobile device to send an auto-reply message to the other mobile device. For example, the auto-reply message may be a predetermined message set by the user of the mobile device (e.g., #hiking, #studying, #working).

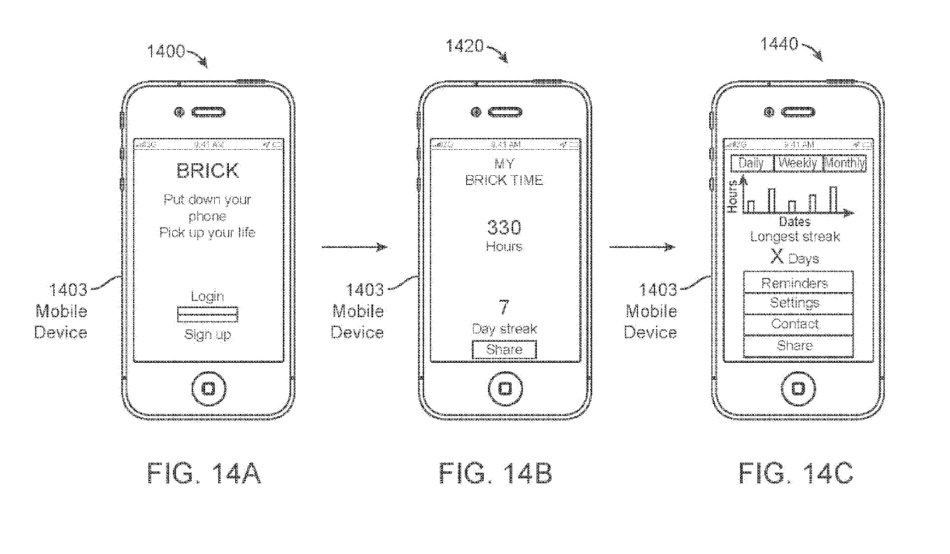

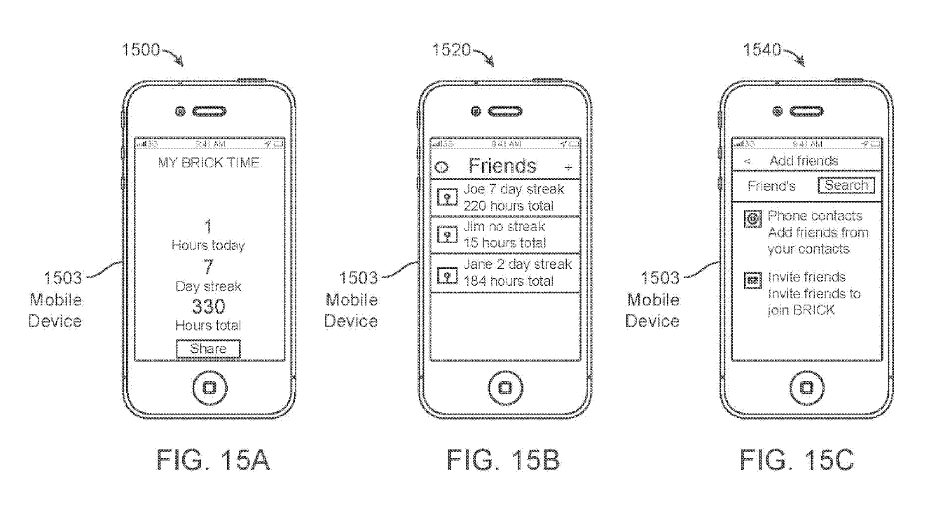

The presentation engine 310 may function to generate one or more graphical user interfaces (GUs). The presentation engine 310 may generate one or more graphical user interfaces displaying a user-disconnection mode. In some embodiments, the presentation engine 310 may function to generate one or more graphical user interfaces for displaying active and/or historical user-disconnection time, and/or other information described herein, such as alerts, user-disconnection time reminders, user-disconnection time streaks, user-disconnection time challenges and awards, auto-reply messages, and/or the like. Example graphical user interfaces are shown in FIGS. 14A-C and FIGS. 15A-C.

The user-disconnection box system interface engine 312 may function to establish and/or receive a network connection (e.g., wireless connection and/or wired connection) with a user-disconnection box and/or user-disconnection box system. For example, the user-disconnection box system interface engine 312 may comprise a Bluetooth interface (e.g., a low-power and/or weak-signal Bluetooth interface).

In some embodiments, the user-disconnection box system interface engine 312 may function to facilitate an identification of a mobile device. For example, the mobile device may include an RFID tag for pairing and/or connecting to an RFID sensor. The user-disconnection box system interface engine 312 may comprise the RFID tag and facilitate communication between the RFID tag and a corresponding RFID sensor.

The communication engine 314 may function to send requests, transmit and, receive communications, and/or otherwise provide communication with one or a plurality of the systems, engines, and/or datastores described herein. In some embodiments, the communication engine 314 functions to encrypt and decrypt communications. The communication engine 314 may function to send requests to and receive data from one or more systems through a network or a portion of a network. Depending upon implementation-specific considerations, the communication engine 314 may send requests and receive data through a connection, all or a portion of which may be a wireless connection. The communication engine 314 may request and receive messages, and/or other communications from associated systems and/or engines. Communications may be stored in the mobile device system datastore 316.

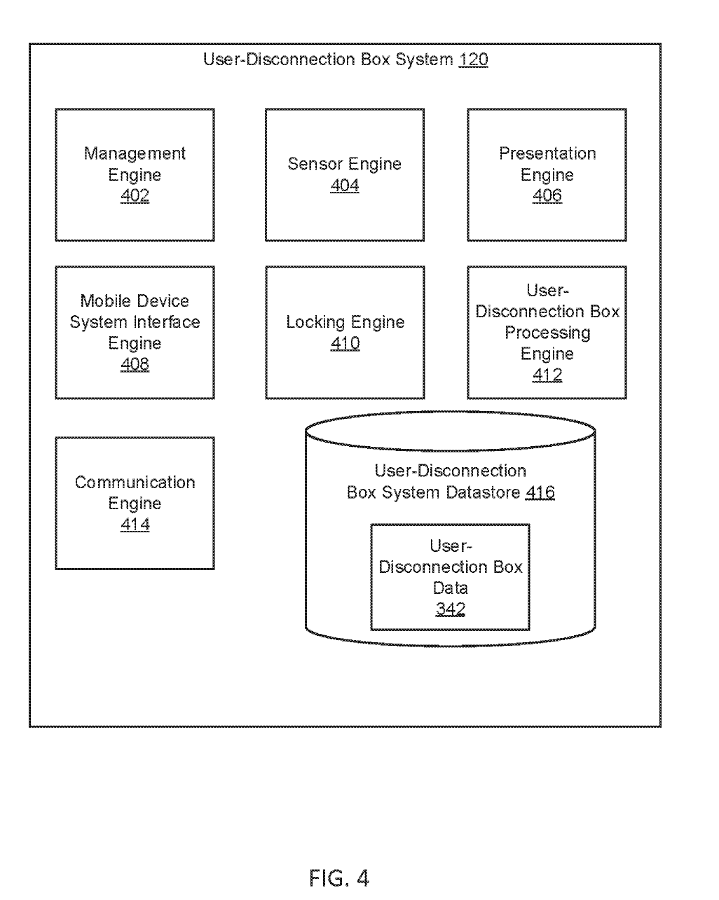

FIG. 4 depicts a user-disconnection box system 120 according to some embodiments. In the example of FIG. 4, the user-disconnection box system 120 includes a management engine 402, a sensor engine 404, a presentation engine 406, a mobile device system interface engine 408, a locking engine 410, a user-disconnection box processing engine 412, a communication engine 414, and a user-disconnection box system datastore 416.

The management engine 402 may function to manage (e.g., create, read, update, delete, or otherwise access) user-disconnection box data 342 stored in the user-disconnection box system datastore 416 and/or other datastore(s) associated with the user-disconnection box system 120. The management engine 402 may perform any of these operations manually (e.g., by a user interacting with a GUI) and/or automatically (e.g., triggered by one or more of the engines 404-412). Like other engines described herein, some or all of the functionality of the management engine 402 may be included in and/or cooperate with one or more other engines (e.g., engines 404-412).

The sensor engine 404 may function to detect placement and/or removal of one or more mobile devices in a user-disconnection box. The sensor engine 404 may detect placement and/or removal based on one or more sensors (e.g., proximity sensors, weight sensors, pressure sensors, near-field communication sensors, Bluetooth sensors, RFID sensors, audio frequency-based sensors, light sensors) disposed within the internal cavity of the housing of the container, and/or elsewhere in or on a user-disconnection box. For example, the sensor engine 404 may use an RFID sensor to identify a corresponding RFID tag attached to a mobile device when the mobile device is inside the user-disconnection box. In some embodiments, the sensor engine 404 may include and/or cooperate with the one or more sensors.

In some embodiments, the sensor engine 404 functions to detect placement and/or removal of one or more mobile devices using near-field communication (NFC). For example, an NFC sensor may be disposed within a user-disconnection box, and when the mobile device is within range of the NFC sensors (e.g., 4 cm), the sensor engine 404 may detect placement and/or removal of that mobile device within the user-disconnection box.

In some embodiments, detecting placement and/or removal may include and/or be based on detecting proximity (e.g., by the sensor engine 404). For example, the sensor engine 404 may detect that a mobile device is proximate to the user-disconnection box (e.g., within a threshold distance) or not proximate to the user-disconnection box (e.g., not within a threshold distance), and assume the mobile device has been placed in the user-disconnection box or not been placed in the user-disconnection box. This may, for example, allow the sensor engine 404 to corroborate placement and/or removal of a mobile device using Bluetooth sensors, NFC sensors, and/or the like.

In some embodiments, the sensor engine 404 functions to identify a mobile device, identify a mobile device system, and/or identify a user. For example, the sensor engine 404 may facilitate pairing of the user-disconnection box to a mobile device and obtaining information from that device (e.g., a mobile device identifier, mobile device system identifier, user identifier). The sensor engine 404 may cooperate with the mobile device system interface engine 408 to pair and/or obtain information.

In some embodiments, the sensor engine 404 functions to control and/or receive sensors data and/or inputs from one or more associated sensors. For example, the sensor engine 404 may function to switch one or more indicator lights (e.g., indicator lights 209) from indicating a user-connected state (e.g., via displaying a red light) to indicating a user-disconnected state (e.g., via displaying a green light). The sensor engine 404 may perform the switching in response to detecting placement of the mobile device in the user-disconnection box and/or removal of the mobile device from the user-disconnection box. The sensor engine 404 may perform the switching in response to detecting the closing of the door (or, lid) of the user-disconnection box with the mobile device inside, and/or the opening of the door (or, lid) and/or removal of the mobile device from the user-disconnection box. In some embodiments, the sensor engine 404 functions to receive inputs from a timer dial. For example, the timer dial may define a period of user-disconnection time (e.g., 2 hours) and/or may lock the user-disconnection box for defined period of user-disconnection time.

In some embodiments, the sensor engine 404 functions to detect a starting condition for logging user-disconnection time for a mobile device and/or a mobile device system included in the mobile device (e.g., installed on the mobile device and/or executing on the mobile device). For example, the starting condition may be detecting a placement of the mobile of the device in a user-disconnection box based on one more sensors and/or based on a scheduled period of user-disconnection time.

In some embodiments, the sensor engine 404 functions to detect an ending condition for terminating logging user-disconnection time for the mobile device. For example, an ending condition may be reaching the end of a scheduled amount of time (e.g., as set using a timer dial, and/or as set via a scheduled calendar event), and/or the mobile device being removed from the user-disconnection box, and/or the user-disconnection box door (or, lid) changing position from closed to open.

In some embodiments, the sensor engine 404 functions to identify, and/or facilitate identifying, identities of multiple mobile devices (e.g., John's iPhone and Marc's iPhone) inside a user-disconnection box, and/or may communicate, and/or facilitate communication, with the identified mobile devices (e.g., to start and/or end user-disconnection time). This may, for example, allow the user-disconnection box (e.g., and/or user-disconnection box system 120) to communicate with multiple mobile devices stored in the user-disconnection box. The sensor engine 404 may cooperate with one or more other engines (e.g., the mobile device system interface engine 408 and/or the communication engine 416) to perform such functionality.

The presentation engine 406 may function to generate and/or control one or more analog and/or digital displays. For example, the presentation engine 406 may generate and display a representation of a timer dial, may generate and display a graphical user interface indicating a status of the user-disconnection box 102 (e.g., locked, unlocked), and/or other information (e.g., time of day, timer). For example, the presentation engine 406 may display user connection state (e.g., user-disconnected state and/or user-connected state). The presentation engine 406 may generate and/or present displays on, and/or using, a portion of a housing of a user-disconnection box and/or a display of a user-disconnection box.

The mobile device system interface engine 408 may function to establish and/or receive a network connection (e.g., wireless connection and/or wired connection) with a mobile device and/or a mobile device system. For example, the mobile device system interface engine 408 may comprise a Bluetooth interface (e.g., a low-power and/or weak-signal Bluetooth interface).

In some embodiments, the mobile device system interface engine 408 may function to facilitate an identification of a corresponding user-disconnection box and/or user-disconnection box system. For example, the mobile device may include an RFID tag for pairing and/or connecting to an RFID sensor. The mobile device system interface engine 408 may comprise the RFID sensor and/or cooperate with the RFID sensor to facilitate communication between the RFID tag and the RFID sensor.

The locking engine 410 may function to trigger locking the user-disconnection box 102. For example, the locking engine 410 may trigger a magnetic lock and/or other type of lock, which may prevent access to an internal cavity of the user-disconnection box 102 and/or other features of the user-disconnection box 102. In some embodiments, the locking engine 410 may lock the user-disconnection box 102 based on a time lock. For example, the locking engine 410 may lock the 410 based on a scheduled period of user-disconnection time (e.g., lock at the start of the period of user-disconnection time, and unlock at the end of the period of user-disconnection time).

In some embodiments, the locking engine 410 (and/or physical locks of a user-disconnection box) may be controlled by a mobile device system (e.g., user-disconnection time scheduler engine 306). For example, user-disconnection time scheduler engine 306 may lock a user-disconnection box at the start of a period of user-disconnection time and/or unlock a user-disconnection box at an end of user-disconnection time.

The user-disconnection box processing engine 412 may function to trigger a user-connected state associated with a mobile device (e.g., in response to the detecting an end of a period of user-disconnection time), which may cause the mobile device system executing on the mobile device to end logging user-disconnection time. In some embodiments, the user-disconnection box processing engine cooperates with user-disconnection time processing engine 304 to trigger the user-connected state and/or end logging user-disconnection time.

In some embodiments, the user-disconnection box processing engine 412 functions to trigger a user-disconnected state associated with a mobile device, which may cause a mobile device system executing on the mobile device to start logging user-disconnection time. For example, the user-disconnection box processing engine 412 may start a timer tracking user-disconnection time and store the information in user-disconnection box data 342. The user-disconnection box processing engine 412 may trigger the disconnected state in response to detecting placement of the mobile device in the user-disconnection box 102.

In some embodiments, the user-disconnection box processing engine 412 functions to detect an end of a period of user-disconnection time. For example, the user-disconnection box processing engine 412 may detect the end of the period of user-disconnection time when a scheduled period of user-disconnection time ends. For example, the period may have been set using a timer dial. In another example, a mobile device may have been removed from the user-disconnection box 102.

In some embodiments, the user-disconnection box processing engine 412 functions to notify and/or facilitate notification of another system of detected starting and/or ending conditions for logging user-disconnection time and/or ending logging user-disconnection time. For example, the user-disconnection box processing engine 412 may notify a mobile device system that a mobile device has been placed in a user-disconnection box and/or removed from a user-disconnection box so that the mobile device system can start logging user-disconnection time and/or end logging user-disconnection time.

In some embodiments, the user-disconnection box processing engine 412 functions to generate and/or provide messages. The user-disconnection box processing engine 412 may function to generate and/or provide user connection state messages (e.g., to a mobile device system and/or server system). The messages may indicate user connection state, a user identifier, a mobile device system identifier, a mobile device identifier, a start of user-disconnection time, an end of user-disconnection time, a calculated total user-disconnection time, and/or the like.

The communication engine 414 may function to send requests, transmit and, receive communications, and/or otherwise provide communication with one or a plurality of the systems, engines, and/or datastores described herein. In some embodiments, the communication engine 414 functions to encrypt and decrypt communications. The communication engine 414 may function to send requests to and receive data from one or more systems through a network or a portion of a network. Depending upon implementation-specific considerations, the communication engine 414 may send requests and receive data through a connection, all or a portion of which may be a wireless connection. The communication engine 414 may request and receive messages, and/or other communications from associated systems and/or engines. Communications may be stored in the user-disconnection box system datastore 416.

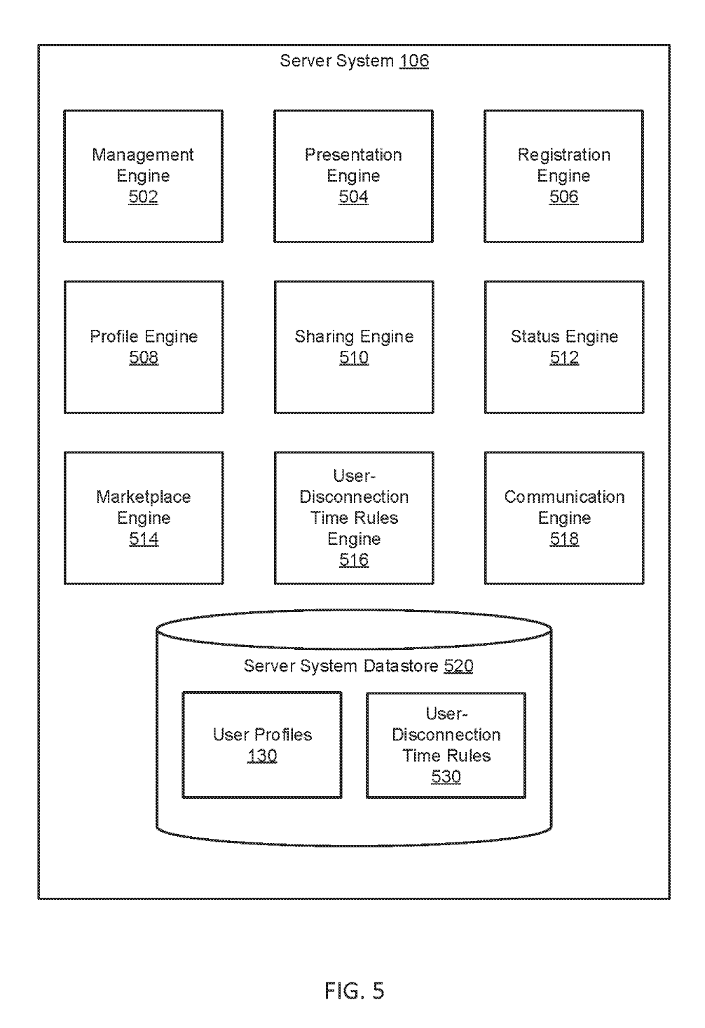

FIG. 5 depicts a server system 106 according to some embodiments. In the example of the FIG. 5, the server system 106 includes a management engine 502, a presentation engine 504, a registration engine 506, a profile engine 508, a sharing engine 510, a status engine 512, a marketplace engine 514, a user-disconnection time rules engine 516, a communication engine 518, and a server system datastore 520.

The management engine 502 may function to manage (e.g., create, read, update, delete, or otherwise access) user profiles 130 and/or user-disconnection time rules 530 stored in the server system datastore 520 and/or other datastore(s) associated with the server system 106. The management engine 502 may perform any of these operations manually (e.g., by a user interacting with a GUI) and/or automatically (e.g., triggered by one or more of the engines 504-518). Like other engines described herein, some or all of the functionality of the management engine 502 may be included in and/or cooperate with one or more other engines (e.g., engines 504-518).

The presentation engine 504 may function to generate one or graphical user interfaces (GUIs). The presentation engine 504 may generate interfaces for some the registration engine 506 and/or other engines. The presentation engine 504 may cooperates with a presentation engine of a mobile device system to provide interfaces on the mobile device system. For example, the presentation engine 504 may provide the server-side functionality, and the presentation engine of the mobile device system may provide the client-side functionality.

The registration engine 506 may function to register users, mobile device system, and/or mobile devices. The registration engine 506 may receive information that may be used to populate user profiles 130, provide security credentials for logging into a user account associated with a user profile 130, and/or the like. For example, some or all of the information of a user profile 130 may be provided during registration and/or during a registration update.

The profile engine 508 may function to create, read, update, and/or delete user profiles 130. User profiles may include some or all of the following:
User profile identifier: identifies the user profile (e.g., alphanumeric and/or hash value)
User identifier(s): identifiers a user associated with the user profile
Security credentials: security credentials (e.g., username, password) used to access an account associated with the user profile
User personal information: name, email address, zip code, phone number, other contact information, pictures, and/or the like
Mobile device system identifier: identifies the mobile device system
Mobile device identifier: identifies the mobile device (e.g., a media access control identifier)
Current user connection state: user-connected state and/or user-disconnected state
User-disconnection time log information: current and/or historical user-disconnection time statistics (e.g., total historical user-disconnection time, today's user-disconnection time, weekly user-disconnection time)
Friends (or “peers”): users that may receive shared information and/or provide shared information to the user
Sharing preferences: particular friends to receive information and/or particular information to share with some or all friends
Auto-reply settings: set an auto-reply message when in user-disconnection time (e.g., #hiking, #studying, #working)
Streak information: current and/or historical user-disconnection time streak information
Challenge information: current and/or historical challenge information (e.g. number of challenges accomplished)

The sharing engine 510 may function to share user connection states and/or other information (e.g., some or all information from a user profile 130). For example, the sharing engine 510 may function to share auto-reply messages, user connection states, user-disconnection historical information, streak information (or broken streak information), challenge information, and/or other information described herein. The sharing engine 510 may be configured to share information over a communication network to one or more remote systems (e.g., social network systems, mobile devices, mobile devices, user-disconnection boxes, user-disconnection box systems, and/or the like). In some embodiments, the sharing engine 510 functions to share information relating to user-disconnection time streaks, user-disconnection time challenges, and/or other information, as described elsewhere herein. Information may be shared with friends, social network systems, and/or associated mobile devices.

The status engine 512 may function to determine user connection state of mobile devices. For example, the status engine 512 may ping a mobile device system and request a user connection state of an associated mobile device (e.g., the mobile device implementing the mobile device system). The status engine 512 may process any responses to the requests, and/or notify other engines. For example, if the status engine 512 receives a user-disconnected state in response to a request, the status engine 512 may notify the profile engine 508 to update a corresponding user profile 130 to user-disconnected status.

The marketplace engine 514 may function to define and/or provide (or, “issue”) marketplace rewards. Marketplace rewards may include digital and/or physical products (e.g., promotional goods and services, digital content, clothing, coupons, discounted memberships, and/or the like). The marketplace engine 514 may provide marketplace rewards based on user-disconnection time. For example, user-disconnection time may be exchanged for marketplace rewards. In some embodiments, some user-disconnection time may be more valuable than other user-disconnection time. For example, user-disconnection time logged between particular hours (e.g., 11 PM and 6 AM) may be worth less than other hours, because it may be assumed the user may have been sleeping during those hours. In some embodiments, user-disconnection time qualifies the user the chance to win marketplace rewards based on a lottery system (e.g., each hour of user-disconnection time counts as one chance to win promotional goods or services, and via a random lottery system, each week a number of users win marketplace rewards out of the entire accumulation of all users' user-disconnection hours).

In some embodiments, the user-disconnection time rules engine 516 functions to calculate user-disconnection time streaks. A streak may include an uninterrupted number of days (and/or other predetermined period of time) of logging at least a threshold amount of user-disconnection time (e.g., 1 hour). In some embodiments, the user may define personal user-disconnection time goals, including a defined amount of user-disconnection time each day (or, week, month). The user-disconnection time rules engine 516 may then evaluate success or failure of user's said defined personal goals. In some embodiments, the user-disconnection time rules engine 516 functions to define and/or evaluate user-disconnection time challenges. User-disconnection time challenges may include logging a predetermined amount a user-disconnection time with in a predetermined amount of time. Challenges may be updated daily, weekly, and/or the like. Completed challenges may provide marketplace rewards.

The communication engine 518 may function to send requests, transmit and receive communications, and/or otherwise provide communication with one or a plurality of the systems, engines, and/or datastores described herein. In some embodiments, the communication engine 518 functions to encrypt and decrypt communications. The communication engine 518 may function to send requests to and receive data from one or more systems through a network or a portion of a network. Depending upon implementation-specific considerations, the communication engine 518 may send requests and receive data through a connection, all or a portion of which may be a wireless connection. The communication engine 518 may request and receive messages, and/or other communications from associated systems and/or engines. Communications may be stored in the server system datastore 520.

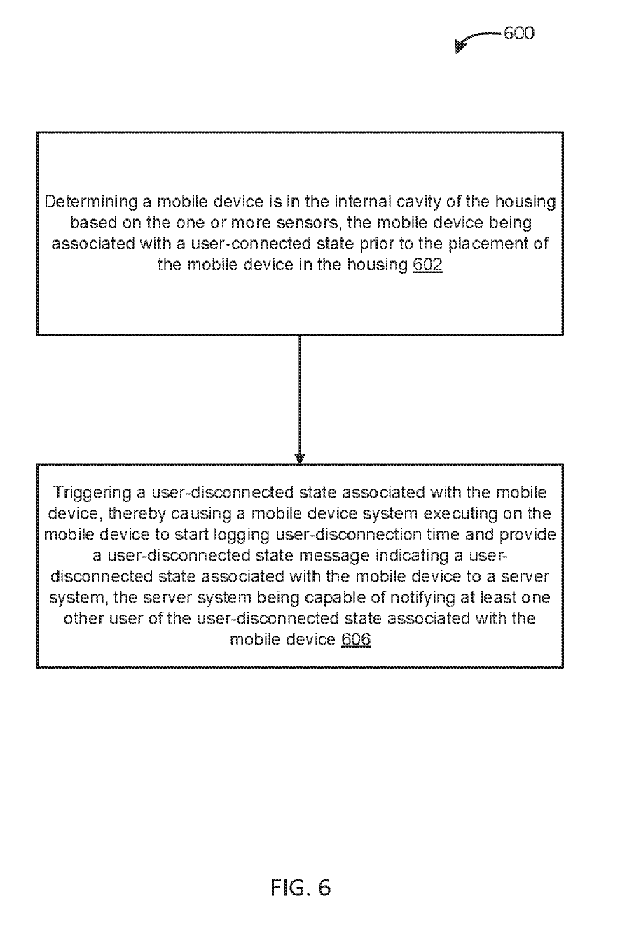

FIG. 6 depicts a flowchart of a method 600 of operation of a user-disconnection box with network connectivity to a server system according to some embodiments. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed but may have been included for the sake of illustrative clarity.

In step 602, a computing system (e.g., user-disconnection box system 120 and/or mobile device system 104) determines a mobile device (e.g., a mobile device 203) is in an internal cavity of a housing (e.g., housing 202) of a container (e.g., user-disconnection box 102). The determination may be based on one or more sensors (e.g., sensor 1320) disposed within the internal cavity of the housing of the container. The mobile device may be associated with a user-connected state prior to the determination the mobile device is in the housing. In some embodiments, a sensor engine (e.g., sensor engine 404) determines the mobile device is in the container.

In some embodiments, the one or more sensors include one or more weight sensors and/or pressure sensors configured to detect one or more weight values and/or pressure values (e.g., ounce, gram, pound, pound per square inch). For example, the one or more sensors may detect (or, sense) a weight and/or a pressure caused by a mobile device placed in contact with at least one of the one or more sensors.

In some embodiments, the one or more sensors include Bluetooth sensors. For example, if the computing system is able to pair with the mobile device using Bluetooth, then the user-computing system may detect the mobile device is placed within the internal cavity of the housing of the container.

In some embodiments, the one or more sensors include NFC sensors. For example, if the computing system is able to pair with the mobile device using NFC, then the user-computing system may detect the mobile as placed within the internal cavity of the housing of the container.

In some embodiments, the one or more sensors include one or more radio-frequency identification (RFID) sensors. The RFID sensors may be configured to identify a corresponding RFID tag attached to the mobile when the mobile is inside the internal cavity of the housing.

In some embodiments, the computing system identifies the mobile device. For example, the sensor engine may identify the mobile device (e.g., based on NFC communication, Bluetooth communications, RFID communication, and/or the like).

In step 606, the computing system triggers a user-disconnected state associated with the mobile device, which may thereby cause a mobile device system (e.g., mobile device system 104) executing on the mobile device to start logging user-disconnection time and provide a user-disconnected state message indicating the user-disconnected state associated with the mobile device to a server system (e.g., server system 106). In some embodiments, the computing system triggers user-disconnection time when the door (or, lid) of the user-disconnection box is closed and/or locked. The server system may be capable of notifying at least one other user (e.g., a friend) of the user-disconnected state associated with the mobile device. The computing system may start a timer that tracks user-disconnection time. The computing system may trigger the disconnected state in response to detecting the placement of the mobile device in the internal cavity of the housing. In some embodiments, a user-disconnection box processing engine (e.g., user-disconnection box processing engine 412) triggers the user-disconnected state. In some embodiments, a user-disconnection time processing engine (e.g., user-disconnection time processing engine 304) starts logging (or, measuring) user-disconnection time, and stores the information in a user-disconnection time log (e.g., user-disconnection time log 340) in a datastore (e.g., mobile device system datastore 316).

In some embodiments, the computing system triggers the user-disconnected state associated with the mobile device when the computing has identified the mobile device and/or detected placement of the mobile device in the internal cavity of the housing.

In some embodiments, the user-disconnected state message indicates the start logging user-disconnection time. For example, the message may include a date and/or time (e.g., Jan. 10, 2018, at 9:34:00 AM) that the user-disconnection time started. The date and/or time may be recorded as a timestamp in the user-disconnection time log.

In some embodiments, the container may include a timer dial (e.g., timer dial 208). The timer dial may be disposed on the external portion of the housing (e.g., the door). The timer dial may be configured to receive one or more inputs for setting a period of user-disconnection time. For example, a user associated with the mobile device may manipulate the dial in a clockwise direction to increase a period of scheduled user-disconnection time, and/or manipulate the timer dial in a counter-clockwise direction to decrease a period of scheduled user-disconnection time. Once a period of user-disconnection time is set, and the mobile device is within the container and the door is closed, the period of user-disconnection time may decrease until it reaches an end of the period and/or other ending condition is satisfied (e.g., removal of the mobile device from the user-disconnection box).

In some embodiments, the mobile device system is configured to provide an auto-reply message in response to one or more messages received while the mobile device is placed within the internal cavity of the housing and the mobile device is associated with a user-disconnected state. For example, if another user using another mobile device sends a text message to the mobile device, the mobile device system may send and/or trigger the mobile device to send an auto-reply message to the other mobile device. For example, the auto-reply message may be a predetermined message set by the user of the mobile device (e.g., #hiking, #studying, #working).

In some embodiments, the container includes a charging cable configured to facilitate charging of the mobile device. For example, the charging cable may connect the mobile device to a power source (e.g., power source 214) via the user-disconnection box. In some embodiments, the container may include an inductive charging pad for inductively and/or wirelessly charging the mobile device.

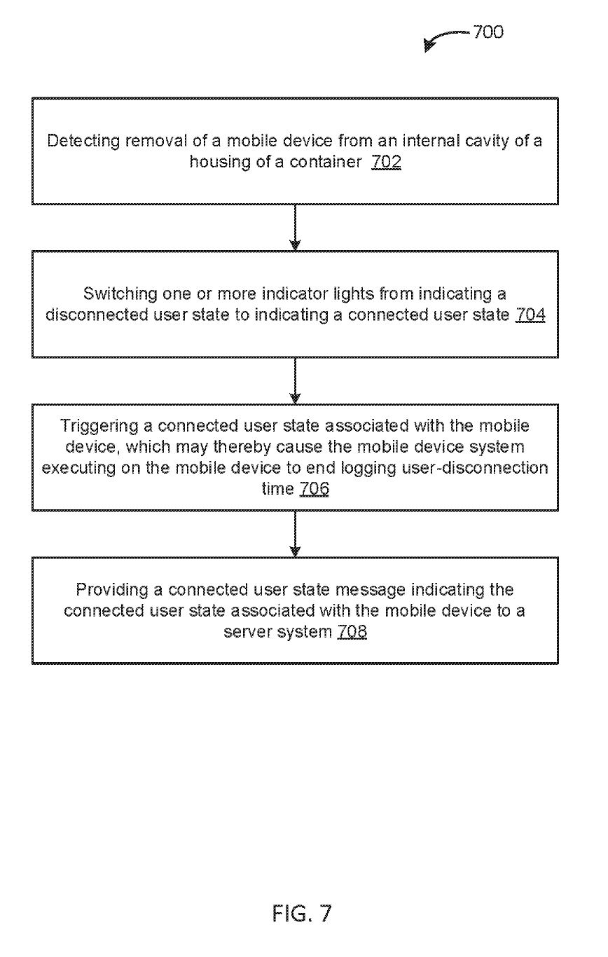

FIG. 7 depicts a flowchart of a method 700 of operation of a user-disconnection box detecting removal of a mobile device according to some embodiments.

In step 702, a computing system (e.g., user-disconnection box system 120 and/or mobile device system 104) detects removal of a mobile device (e.g., mobile device 203) from an internal cavity of a housing (e.g., housing 202) of a container (e.g., user-disconnection box 102). The mobile device 203 may include a mobile device system (e.g., mobile device system 104). The detection may be based on the one or more sensors (e.g., sensors 1320) included in the container. In some embodiments, a sensor engine (e.g., 404) detects the removal of the mobile device.

In step 704, the computing system switches one or more indicator lights (e.g., indicator lights 209) from indicating a user-disconnected state to indicating a user-connected state (e.g., in response to detecting the removal of the mobile device in the internal cavity of the housing, or in response to the opening of the user-disconnection box door/lid). In some embodiments, the sensor engine switches the one or more indicator lights. In some embodiments, step 704 occurs when the user-disconnection box door/lid changes position from closed to open, without need for step 702 to occur first.

In step 706, the computing system triggers a user-connected state associated with the mobile device (e.g., in response to detecting the removal of the mobile device from the internal cavity of the housing, or in response to the opening of the user-disconnection box door/lid), which may thereby cause the mobile device system executing on the mobile device to end logging user-disconnection time. For example, computing system may end a timer tracking user-disconnection time. In some embodiments, a user-disconnection time processing engine (e.g., user-disconnection time processing engine 304) ends logging user-disconnection time. For example, the user-disconnection time processing engine may log the end time as date and/or time (e.g., as a timestamp) in a user-disconnection time log (e.g., user-disconnection time log 340) stored in a datastore (e.g., mobile device system datastore 316). The user-disconnection time processing engine may also calculate and/or measure an amount of user-disconnection time (e.g., 4 hours, 32 minutes, and 7 seconds) based on the start and/or end times (e.g., convert the start time to a first value, convert the end to a second value, subtract the first time from the second time to obtain a third value, and convert the third value in to a time format).

In some embodiments, the trigger further causes the mobile device system to provide a user-connected state message indicating the user-connected state associated with the mobile device to a server system (e.g., server system 106). The message may be provided in response to detecting the removal of the mobile device from the internal cavity of the housing, or in response to the opening of the user-disconnection box door/lid. The server system may be capable of notifying the at least one other user of the user-connected state associated with the mobile device.

In step 708, the computing system provides a user-connected state message indicating the user-connected state associated with the mobile device to a server system (e.g., server system 106). The message may be provided in response to detecting the removal of the mobile device from the internal cavity of the housing, or in response to the opening of the user-disconnection box door/lid. The server system may be capable of notifying the at least one other user of the user-connected state associated with the mobile device. In some embodiments, a communication engine (e.g., communication engine 414) provides the message to the server system over a communications network (e.g., communications network 110).

In some embodiments, the user-connected state message indicates the end logging user-disconnection time. For example, the message may include a date and/or time (e.g., Jan. 10, 2018, at 2:06:07 PM) that the user-disconnection time ended. The date and/or time may be recorded as a timestamp in the user-disconnection time log.

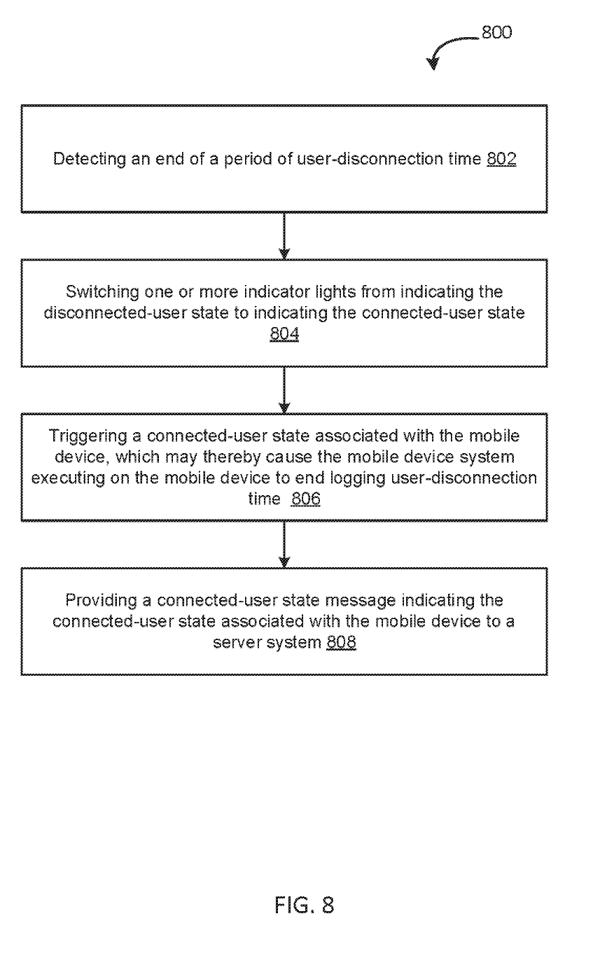

FIG. 8 depicts a flowchart of a method 800 of operation of a user-disconnection box detecting an end of a period of user-disconnection time according to some embodiments.

In step 802, a computing system (e.g., user-disconnection box system 120 and/or mobile device system 104) detects an end of a period of user-disconnection time. For example, the computing system may detect the end of the period of user-disconnection time when a scheduled period of user-disconnection time ends. The period may have been set using a timer dial (e.g., timer dial 208) and/or using a mobile device system (e.g., mobile device system 104). In some embodiments, a user-disconnection box processing engine (e.g., user-disconnection box processing engine 412) detects the end of the period of user-disconnection time, and stores the information (e.g., user-disconnection box data) in a datastore (e.g., user-disconnection box system datastore 416). In some embodiments, the computing system of the mobile device system 104 may detect the end of the period of user-disconnection time when the user-disconnection box 102 door (or, lid) opens. In some embodiments, the mobile device system 104 detects the end of a period of user-disconnection time without a user-disconnection box processing engine and/or box system datastore 416. In some embodiments, the user-disconnection box data is stored in the mobile device system datastore 316.

In step 804, the computing system switches one or more indicator lights (or, sounds, haptics, and/or the like) (e.g., indicator lights 209) from indicating the user-disconnected state to indicating the user-connected state (e.g., in response to the detecting end of the period of user-disconnection time). In some embodiments, a sensor engine (e.g., sensor engine 404) switches the one or more indicator lights.

In step 806, the computing system triggers a user-connected state associated with the mobile device (e.g., in response to the detecting an end of the period of user-disconnection time), which may thereby cause the mobile device system executing on the mobile device to end logging user-disconnection time. In some embodiments, the user-disconnection box processing engine cooperates with user-disconnection time processing engine (e.g., user-disconnection time processing engine 304) to trigger the user-connected state and/or end logging user-disconnection time.

In some embodiments, the triggering further causes the mobile device system to provide a user-connected state message indicating the user-connected state associated with the mobile device to a server system (e.g., server system 106). The computing system may provide the message in response to detecting an end of the period of user-disconnection time. The server system may be capable of notifying at least one other user of the user-connected state associated with the mobile device.

In step 808, the computing system provides a user-connected state message indicating the user-connected state associated with the mobile device to a server system (e.g., server system 106). The computing system may provide the message in response to the detecting an end of the period of user-disconnection time. The server system may be capable of notifying at least one other user of the user-connected state associated with the mobile device. In some embodiments, the user-disconnection box processing engine and/or a communication engine (e.g., communication engine 414) provides the message over a communications network (e.g., communications network 110).

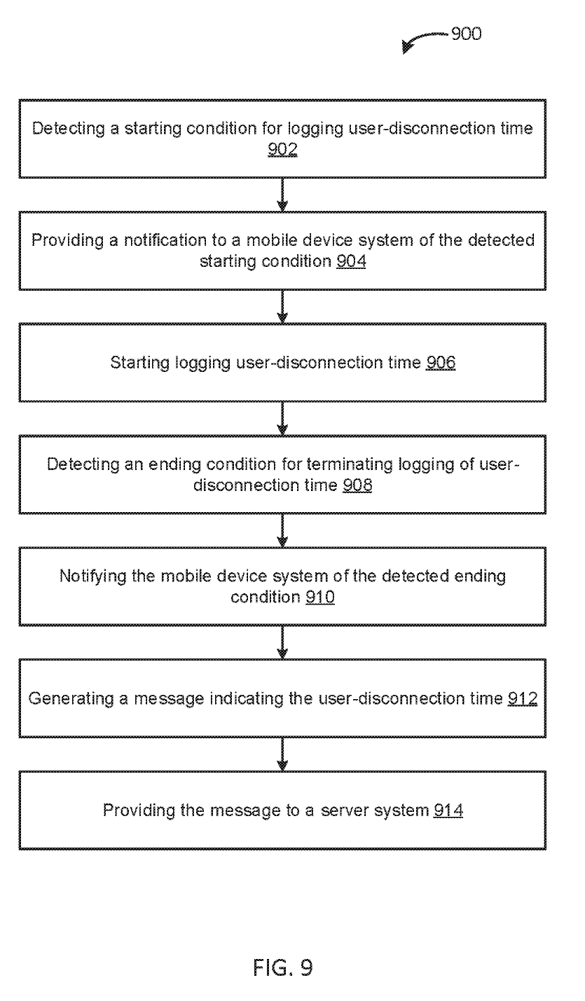

FIG. 9 depicts a flowchart of a method 900 of operation of a user-disconnection box without network connectivity to a server system according to some embodiments.

In step 902, a user-disconnection box system (e.g., user-disconnection box system 120) detects a starting condition for logging user-disconnection time for a mobile device (e.g., mobile device 203) and/or a mobile device system (e.g., mobile device system 104) included in the mobile device (e.g., installed on the mobile device and/or executing on the mobile device). For example, the starting condition may be detecting a placement of the mobile of the device in a container (e.g., user-disconnection box 102) based on one more sensors (e.g., sensors 1320) and/or based on a scheduled period of user-disconnection time, and/or the closing of the user-disconnection box door/lid. In some embodiments, a sensor engine (e.g., sensor engine 404) detects the starting condition.

In step 904, the user-disconnection box system notifies the mobile device system of the detected starting condition for logging user-disconnection time for the mobile device. In some embodiments, a user-disconnection box processing engine (e.g., user-disconnection box processing engine 404) and/or communication engine (e.g., communication engine 414) notifies the mobile device system over a network connection (e.g., low-power Bluetooth connection, or Wi-Fi connection). In some embodiments, the network connection is provided by a mobile device system interface engine (e.g., mobile device system interface engine 408) of the user-disconnection box system cooperating with a user-disconnection box system interface engine (e.g., user-disconnection box system interface engine 312) of the mobile device system.

In step 906, the mobile device system starts logging user-disconnection time. For example, the mobile device system may start a timer of the mobile device system that tracks user-disconnection time and/or stores the information in a user-disconnection time log (e.g., user-disconnection time log 340). In some embodiments, a user-disconnection time processing engine (e.g., user-disconnection time processing engine 304) starts logging user-disconnection time. It will be appreciated that in some embodiments the user-disconnection box system may log user-disconnection time instead of, and/or in addition to, the mobile device system.

In step 908, the user-disconnection box system detects an ending condition for terminating logging user-disconnection time for the mobile device. For example, an ending condition may be reaching an end of a scheduled amount of time (e.g., set using timer dial 208, or set via a scheduled calendar event using the mobile device system), and/or the mobile device being removed from the user-disconnection box, and/or the opening of the user-disconnection box door (or, lid). In some embodiments, the sensor engine detects the ending condition.

In step 910, the user-disconnection box system notifies the mobile device system of the detected ending condition for terminating logging user-disconnection time for the mobile device. In some embodiments, the user-disconnection box processing engine and/or the communication engine notifies the mobile device system over the network connection.

In step 912, the mobile device system generates a message indicating the user-disconnection time for the mobile device. For example, the user-disconnection time may include the starting time, the ending time, and/or total user-disconnection time (e.g., the difference between the starting and ending times). In some embodiments, the user-disconnection time processing engine and/or a communication engine (e.g., communication engine 314) generates the message.

In step 914, the mobile device system provides the message indicating the user-disconnection time for the mobile device to a server system (e.g., server system 106). In some embodiments, the message is mobile device-specific (or mobile device system-specific) user-disconnection logged data. In some embodiments, the communication engine provides the message to the server system.

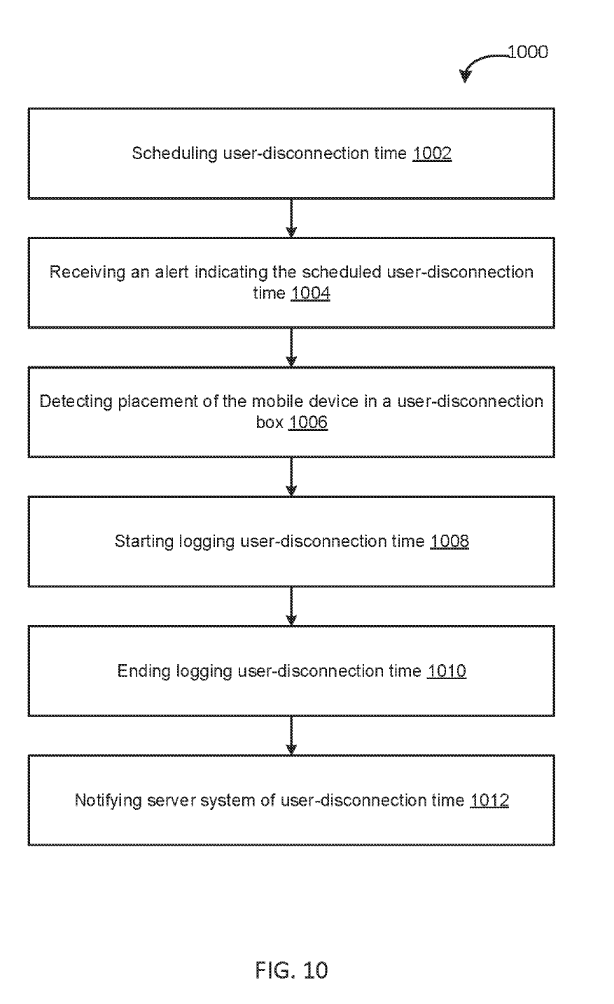

FIG. 10 depicts a flowchart of a method 1000 of operation of a mobile device system (e.g., mobile device system 104) and a user-disconnection box according to some embodiments.

In step 1002, a mobile device system (e.g., mobile device system 104) schedules user-disconnection time (e.g., a specific time of day every day, or a specific time of day on one or more specific days of the week). The mobile device system may be implemented by a mobile device (e.g., mobile device 203). In some embodiments, a user-disconnection time scheduler engine (e.g., user-disconnection time scheduler engine 306) schedules the user-disconnection time. For example, the user-disconnection time scheduler engine may schedule user-disconnection time for January 18 at 2:00 PM, and/or add a calendar event on a calendar of the mobile device system and/or mobile device (e.g., an Outlook calendar event), which may be shared with one or more users, uploaded to a server system (e.g., server system 106), stored in an associated user profile (e.g., user profile 130), and/or the like.

In other embodiments, a user-disconnection box system (e.g., user-disconnection box system 120) schedules the user-disconnection time. For example, a sensor engine (e.g., sensor engine 404) may control and/or interact with a timer dial (e.g., timer dial 208) to schedule user-disconnection time based on inputs of the timer dial (e.g., scheduling 2 hours of user-disconnection time).

In step 1004, the mobile device system receives an alert indicating the scheduled user-disconnection time has arrived. In some embodiments, the user-disconnection time scheduler engine receives the alert, and/or a presentation engine (e.g., presentation engine 310) displays the alert.

In step 1006, a user-disconnection box system detects placement of a mobile device including the mobile device system in a user-disconnection box (e.g., user-disconnection box 102) and/or detects the closing of the user-disconnection box door (or, lid). In some embodiments, the sensor engine detects the placement.

In step 1008, the mobile device system starts logging user-disconnection time. For example, the user-disconnection box system may notify mobile device system of the detected placement, and a user-disconnection time processing engine (e.g., user-disconnection time processing engine 304) starts logging user-disconnection time, and stores the information in a user-disconnection time log (e.g., user-disconnection time log 340). In some embodiments, a presentation engine (e.g. presentation engine 310) displays user-disconnection status and/or the logging of user-disconnection time.

In step 1010, the mobile device system ends logging user-disconnection time. For example, the mobile device system may detect an end of the scheduled user-disconnection time, or the user-disconnection box system may detect an end of scheduled user-disconnection time and/or detect a removal of the mobile device from the user-disconnection box and notify the mobile device system and/or detect the opening of the user-disconnection box door (or, lid). In some embodiments, the user-disconnection time processing engine ends logging user-disconnection time. In some embodiments, a presentation engine (e.g. presentation engine 310) on the mobile device system displays user-disconnection time log and other associated user-disconnection session data (e.g. the user-disconnection time log, start time, end time, and/or total user-disconnection time).

In step 1012, the mobile device system notifies a server system (e.g., server system 106) of the user-disconnection time. In some embodiments, a communication engine (e.g., communication engine 314) provides a notification over a communications network (e.g., communications network 110). The notification may include the user-disconnection time log, start time, end time, and/or total user-disconnection time.

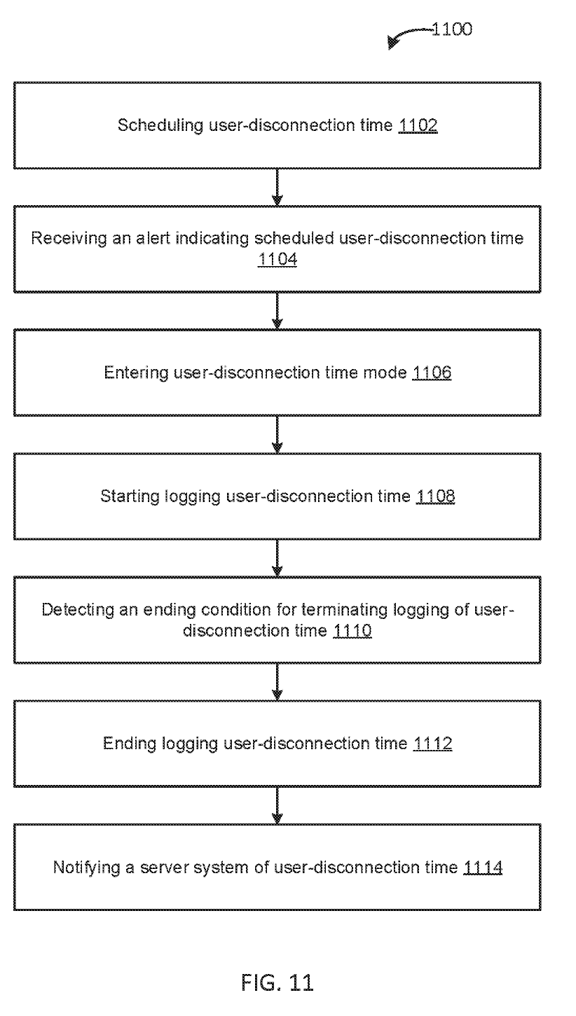

FIG. 11 depicts a flowchart of a method 1100 of operation of a mobile device system without an associated user-disconnection box, according to some embodiments.

In step 1102, a mobile device system (e.g., mobile device system 104) schedules user-disconnection time. The mobile device system may be implemented by a mobile device (e.g., mobile device 203). In some embodiments, a user-disconnection time scheduler engine (e.g., user-disconnection time scheduler engine 306) schedules the user-disconnection time. For example, the user-disconnection time scheduler engine may schedule user-disconnection time for January 18 at 2:00 PM, and/or add a calendar event on a calendar of the mobile device system and/or mobile device (e.g., an Outlook calendar event), which may be shared with one or more users, uploaded to a server system (e.g., server system 106), stored in an associated user profile (e.g., user profile 130), and/or the like.

In step 1104, the mobile device system receives an alert indicating the scheduled user-disconnection time. In some embodiments, the user-disconnection time scheduler engine receives the alert, and/or a presentation engine (e.g., presentation engine 310) displays the alert. In some embodiments, step 1104 and 1106 of method 1100 are omitted and begins on step 1106.

In step 1106, the mobile device system enters user-disconnection mode. For example, a user operating a mobile device may launch the mobile device system on the mobile device. The user may then restrict one or more features of the mobile device (e.g., place the mobile device in airplane mode and/or do not disturb while driving mode), and return to an interface of the mobile device system (e.g., presented by the presentation engine). This may place the mobile device system in user-disconnection mode and/or navigating to a specific screen (or, tapping a specific button) of the presentation engine may place the mobile device system in user-disconnection mode. Navigating away from the interface and/or otherwise interacting the mobile device and/or mobile device system may exit user-disconnection mode. In some embodiments, a user-disconnection time processing engine enters user-disconnection mode.

In step 1108, the mobile device system starts logging user-disconnection time. For example, the mobile device system may start a timer of the mobile device system that tracks user-disconnection time and/or stores the information in a user-disconnection time log (e.g., user-disconnection time log 340). In some embodiments, a user-disconnection time processing engine (e.g., user-disconnection time processing engine 304) starts logging user-disconnection time. It will be appreciated that in some embodiments the user-disconnection box system may log user-disconnection time instead of, and/or in addition to, the mobile device system.

In step 1110, the mobile device system detects an ending condition. For example, the mobile device system may detect an end of the scheduled user-disconnection time, or the user-disconnection box system may detect an end of scheduled user-disconnection time and/or detect a removal of the mobile device from the user-disconnection box and/or change in position of the door (or, lid) of the user-disconnection box from closed to open, and notify the mobile device system. In some embodiments, the user-disconnection time processing engine detects the ending condition.

In step 1112, the mobile device system ends logging user-disconnection time. In some embodiments, the user-disconnection time processing engine ends logging user-disconnection time based on and/or in response to detecting the ending condition.

In step 1114, the mobile device system notifies a server system of the logged user-disconnection time. In some embodiments, a communication engine (e.g., communication engine 314) notifies the server system.

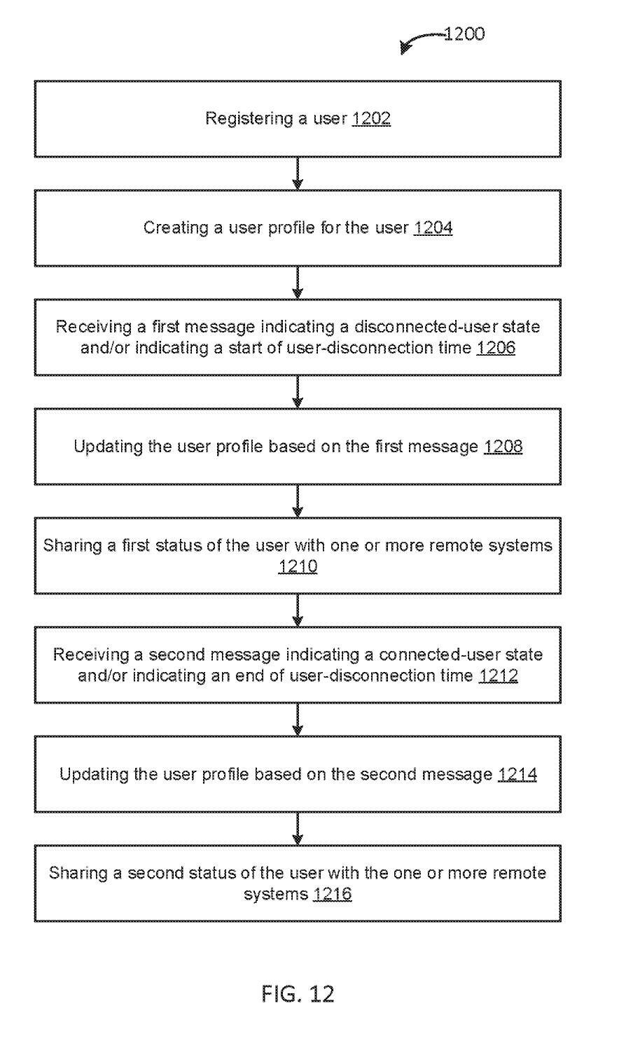

FIG. 12 depicts a flowchart of a method 1200 of operation of a server system according to some embodiments.

In step 1202, a server system (e.g., server system 106) registers a user. In some embodiments, a registration engine (e.g., registration engine 506) registers the user.

In step 1204, the server system creates a user profile for the user. In some embodiments, the registration engine and/or a profile engine (e.g., profile engine 508) creates the user profile).

In step 1206, the server system receives a first message (or, data) indicating a user-disconnected state and/or indicating a start of user-disconnection time. In some embodiments, a communication engine (e.g., communication engine 518) receives the first message over a communications network (e.g., communications network 110).

In step 1208, the server system updates the user profiles based on the first message. In some embodiments, the profile engine updates the disconnected-user state and/or other data on the user profile.

In step 1210, the server system shares a first status of the user with one or more remote systems. For example, the first status may indicate a disconnected state (e.g., #hiking, #studying, #working). In some embodiments, a sharing engine (e.g., sharing engine 510) shares the first status with one or more social network system (e.g., social network systems 108) over the communications network.

In step 1212, the server system receives a second message indicating a user-connected state and/or indicating an end of user-disconnection time. The second message may also include total user-disconnection time (e.g., difference between the start and end time). In some embodiments, the communication engine receives the second message over the communications network.

In step 1214, the server system updates the user profile for the user based on the second message. In some embodiments, the profile engine updates the user profile.

In step 1216, the server system shares a second status with the one or more remote systems. The second status may indicate a connected state and/or an amount of the user-disconnection time from that session. The second status may also include other user-disconnection session statistics (e.g., updated daily streak, total user-disconnection time today, total user-disconnection time this week, total all-time user-disconnection time). In some embodiments, the sharing engine shares the second status with the social network system over the communications network.

FIGS. 13A-B depict a configuration of a user-disconnection box 102 according to some embodiments. In the example of FIG. 13A, the user-disconnection box 102 includes a housing 1302, a door (or, lid) 1304, a power cable 1306 and a sensor 1320. The sensor may comprise of a weight sensor, a pressure sensor, proximity sensor, audio sensor, light sensor, and/or RFID sensor. The housing 1302 may be configured to define an internal cavity configured to store a single mobile device 1303. The power cable 1306 may connect to a power source 1308 to provide power to the user-disconnection box 102 and/or mobile device 1303. Power may not be necessary at all.

In the example of FIG. 13B, the user-disconnection box includes a housing 1302, a door (or, lid) 1304, indicator lights 1309, a timer dial 1318, and lock 1312. The lock 1312 may comprise a magnetic lock and/or other type of lock.

FIGS. 14A-C depict graphical user interfaces 1400-1440 of a mobile device system 104 according to some embodiments. The graphical user interfaces 1400-1440 may be generated by a mobile device system (e.g., by a presentation engine 310) implemented by mobile device 1403. The GUI 1400 comprises a splash page or home page for the mobile device system. The GUI 1420 displays historical user-disconnection “Brick™” time and user-disconnection time streak information, and an option to share the user-disconnection time streak information. The GUI 1440 displays additional information relating to user-disconnection time, reminders (or, alerts, calendar alerts, notifications), settings, sharing (e.g. on social media sites such as Instagram), contacts, user-disconnection time streaks, historical user-disconnection time, and infographics on user-disconnection time.

FIGS. 15A-C depict graphical user interfaces 1500-1540 of a mobile device system 104 according to some embodiments. The graphical user interfaces 1500-1540 may be generated by a mobile device system (e.g., by a presentation engine 310) implemented by mobile device 1503. The GUI 1500 displays historical user-disconnection time, and an option to share user-disconnection statistics. GUI 1520 may display friend information including daily streak information of each friend, and other user-disconnection session statistics of each friend (e.g., total user-disconnection time today, total user-disconnection time this week, total all-time user-disconnection time). GUI 1540 displays an interface for adding and/or inviting friends.

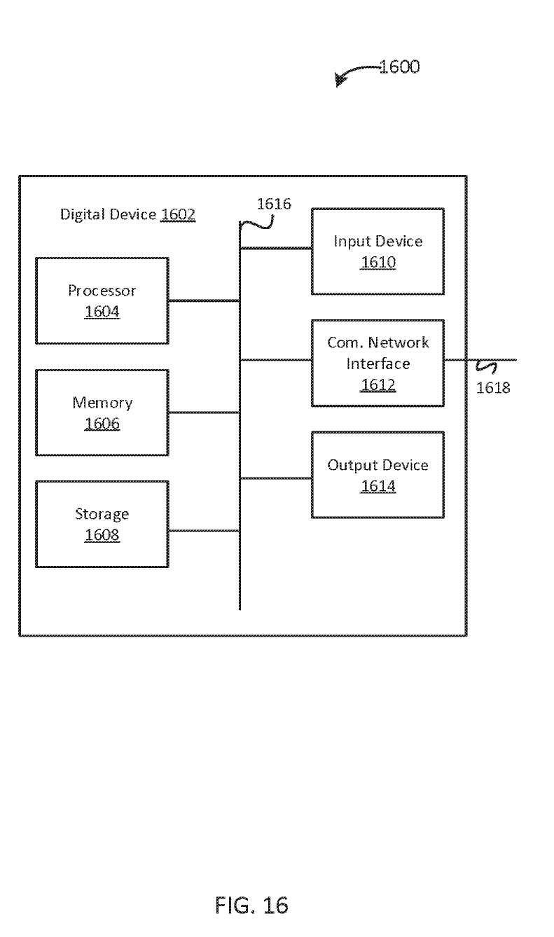

FIG. 16 depicts a diagram 1600 of an example of a computing device 1602. Any of the systems, engines, datastores, and/or networks described herein may comprise an instance of one or more computing devices 1602. In some embodiments, functionality of the computing device 1602 is improved to perform some or all of the functionality described herein. The computing device 1602 comprises a processor 1604, memory 1606, storage 1608, an input device 1610, a communication network interface 1612, and an output device 1614 communicatively coupled to a communication channel 1616. The processor 1604 is configured to execute executable instructions (e.g., programs). In some embodiments, the processor 1604 comprises circuitry or any processor capable of processing the executable instructions.

The memory 1606 stores data. Some examples of memory 1606 include storage devices, such as RAM, ROM, RAM cache, virtual memory, etc. In various embodiments, working data is stored within the memory 1606. The data within the memory 1606 may be cleared or ultimately transferred to the storage 1608.

The storage 1608 includes any storage configured to retrieve and store data. Some examples of the storage 1608 include flash drives, hard drives, optical drives, cloud storage, and/or magnetic tape. Each of the memory system 1606 and the storage system 1608 comprises a computer-readable medium, which stores instructions or programs executable by processor 1604.

The input device 1610 is any device that inputs data (e.g., mouse and keyboard or taps on a touchscreen). The output device 1614 outputs data (e.g., a speaker or display). It will be appreciated that the storage 1608, input device 1610, and output device 1614 may be optional. For example, the routers/switchers may comprise of the processor 1604 and memory 1606 as well as a device to receive and output data (e.g., the communication network interface 1612 and/or the output device 1614).

The communication network interface 1612 may be coupled to a network (e.g., network 110) via the link 1618. The communication network interface 1612 may support communication over an Ethernet connection, a serial connection, a parallel connection, and/or an ATA connection. The communication network interface 1612 may also support wireless communication (e.g., 802.11 a/b/g/n, WiMax, LTE, WiFi). It will be apparent that the communication network interface 1612 may support many wired and wireless standards.

It will be appreciated that the hardware elements of the computing device 1602 are not limited to those depicted in FIG. 16. A computing device 1602 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1604 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A container for supporting user disconnection from one or more mobile devices, the container comprising:
a housing comprising an internal cavity and a door providing access to the internal cavity, the internal cavity being configured to store one or more mobile devices;
one or more sensors disposed within the internal cavity of the housing,
one or more processors; and
memory storing instructions that, when executed by the one or more processors, cause a computing system to perform:
determining a mobile device is in the internal cavity of the housing based on the one or more sensors, the mobile device being associated with a user-connected state prior to the placement of the mobile device in the housing; and
triggering, in response to the determining the mobile device is in the internal cavity of the housing, a user-disconnected state associated with the mobile device, thereby causing a mobile device system executing on the mobile device to start logging user-disconnection time and provide a user-disconnected state message indicating a user-disconnected state associated with the mobile device to a server system, the server system being capable of notifying at least one other user of the user-disconnected state associated with the mobile device.

2. The container of claim 1, wherein the one or more sensors comprise one or more weights sensors configured to detect one or more weight values of a mobile device placed in contact with at least one of the one or more weight sensors.

3. The container of claim 1, wherein the one or more sensors comprise one or more radio-frequency identification (RFID) sensors configured to identify a corresponding RFID tag attached to the mobile when the mobile is inside the internal cavity of the housing.

4. The container of claim 1, wherein the user-disconnected state message indicates the start logging user-disconnection time.

5. The container of claim 1, wherein the instructions further cause the computing system to perform:
determining the mobile device is not in the internal cavity of the housing based on the one or more sensors; and
triggering, in response to the determining the mobile device is not in the internal cavity of the housing, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

6. The container of claim 5, wherein the user-connected state message indicates the end logging user-disconnection time.

7. The container of claim 1, wherein the container further includes a timer dial disposed on the external portion of the housing, the timer dial configured to receive one or more inputs for setting a period of user-disconnection time.

8. The container of claim 7, wherein the instructions further cause the computing system to perform:
detecting an end of the period of user-disconnection time; and
triggering, in response to the detecting an of the period of user-disconnection time, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

9. The container of claim 1, wherein the mobile device system is configured to provide an auto-reply message in response to one or more messages received while the mobile device is placed within the internal cavity of the housing and the mobile device is associated with a user-disconnected state.

10. The container of claim 1, further comprising a charging cable configured to facilitate charging of the mobile device.

11. A method being implemented by a computing system including one or more physical processors and storage media storing machine-readable instructions, the method comprising:
determining, based on one or more sensors disposed within an internal cavity of a housing of a container, a mobile device is in the internal cavity of the housing, the mobile device being associated with a user-connected state prior to the determining the mobile device is in the housing; and
triggering, in response to the detecting placement of the mobile device in the internal cavity of the housing, a user-disconnected state associated with the mobile device, thereby causing a mobile device system executing on the mobile device to start logging user-disconnection time and provide a user-disconnected state message indicating a user-disconnected state associated with the mobile device to a server system, the server system being capable of notifying at least one other user of the user-disconnected state associated with the mobile device.

12. The method of claim 11, wherein the one or more sensors comprise one or more weights sensors configured to detect one or more weight values of a mobile device placed in contact with at least one of the one or more weight sensors.

13. The method of claim 11, wherein the one or more sensors comprise one or more radio-frequency identification (RFID) sensors configured to identify a corresponding RFID tag attached to the mobile when the mobile is inside the internal cavity of the housing.

14. The method of claim 11, wherein the user-disconnected state message indicates the start logging user-disconnection time.

15. The method of claim 11, further comprising:
determining the mobile device is not in the internal cavity of the housing based on the one or more sensors; and
triggering, in response to the detecting removal of the mobile device from the internal cavity of the housing, a user-connected state associated with the mobile device, thereby causing the mobile device system executing on the mobile device to end logging user-disconnection time and provide a user-connected state message indicating the user-connected state associated with the mobile device to the server system, the server system being capable of notifying the at least one other user of the user-connected state associated with the mobile device.

16. The method of claim 15, wherein the user-connected state message indicates the end logging user-disconnection time.

17. The method of claim 11, wherein the container further includes a timer dial disposed on the external portion of the housing, the timer dial configured to receive one or more inputs for setting a period of user-disconnection time.

18. The method of claim 17, further comprising:
detecting an end of the period of user-disconnection time;
switching, in response to the detecting end of the period of user-disconnection time, the one or more indicator lights from indicating the user-disconnected state to indicating the user-connected state; and
triggering, in response to the detecting an end of the period of user-disconnection time, a user-connected state associated with the mobile device, thereby causing the mobile device system executing on the mobile device to end logging user-disconnection time provide a user-connected state message indicating the user-connected state associated with the mobile device to the server system, the server system being capable of notifying the at least one other user of the user-connected state associated with the mobile device.

19. The method of claim 11, wherein the mobile device system is configured to provide an auto-reply message in response to one or more messages received while the mobile device is placed within the internal cavity of the housing and the mobile device is associated with a user-disconnected state.

20. The method of claim 11, wherein the container further comprises a charging cable configured to facilitate charging of the mobile device.
